(19) United States
(12) Patent Application Publication
(10) Pub. No.: US 2004/0249599 A1
(43) Pub. Date: Dec. 9, 2004

(54) Information processing system, information processing apparatus, and information processing method

(76) Inventors: Kiyoshi Masuda, Kyoto (JP); Tatsuro Onuki, Kyoto (JP); Shozo Kano, Kyoto (JP)

Correspondence Address: FOLEY AND LARDNER, SUITE 500, 3000 K STREET NW, WASHINGTON, DC, 20007, US

(21) Appl. No.: 10/489,428

(22) PCT Filed: Sep. 12, 2002
(86) PCT No.: PCT/JP02/09323

(30) Foreign Application Priority Data
Sep. 13, 2001 (JP) 2001-277612
Sep. 17, 2001 (JP) 2001-281029

(51) Int. Cl. G06F 15/00

(52) U.S. Cl. 702/128

(57) ABSTRACT

The present invention relates to an information processing system which allows data acquired by sensors to be used in a simple manner. Sensors 12-1 to 12-N for measuring remaining amounts are provided respectively at tanks 11-1 to 12-N. Data relating to the remaining amounts of the tanks 11-1 to 12-N as measured by the sensors 12-1 to 12-N is transmitted by a controller 13 in a unified fashion to another device that is connected via a network. The other device predicts the date and time at which the remaining amount in a tank 11 will become zero, on the basis of the data thus received. Replenishment of the material to the tank 11 is carried out on the basis of this prediction. The prediction is calculated on the basis of the remaining amount in the tank 11, and the time period required for this remaining amount to be reached. The present invention is applicable to an information processing system in which sensors at a remote location are managed and information from those sensors is processed and used.

### TECHNICAL FIELD

The present invention relates to an information processing system, information processing device and information processing method, and more particularly, to an information processing system, an information processing device and an information processing method, whereby management of a plurality of sensors disposed in a distant position can be carried out in a simple fashion, and whereby data obtained by means of these sensors can be utilized readily.

### BACKGROUND ART

In the case of fuel oil, or the like, which is managed in a prescribed location, for example, in respective households, the user who is managing the fuel oil, or the like, in a particular household assesses the amount of fuel oil remaining, and if the user determines that replenishment is necessary, then he or she makes contact with a supplier and requests a delivery thereof. In this way, replenishment is carried out by means of processed performed by people.

If replenishment is carried out by means of processes performed by people as described above, then a problem will occur if the user managing the fuel oil does not assess the remaining amount of fuel oil correctly, and if replenishment is therefore not carried out at the right time. In other words, replenishing the supply of fuel oil when there is still a large amount remaining is not efficient, and furthermore, replenishing the supply of fuel oil at too late a timing will cause a problem in that the remaining amount will become zero.

Furthermore, even if, in order to avoid the processes performed by people described above as far as possible, it is conceived that the user may wish to manage the remaining amount of fuel oil, him or herself, by means of sensors, or the like, the user still has to connect the sensors to the device to which they correspond, and also has to carry out operations using that device, and furthermore, there may also be cases where the user does not have the specific knowledge required to perform these operations, depending on the type of device, and problems may occur in that operation is difficult for inexperienced users to perform, and the like.

Moreover, if it is wished to obtain data from sensors positioned at a plurality of points, or from different sensors, the corresponding application must be used in order to carry out management tasks for each sensor, and the like, and hence the work burden on the user is significant and the user will frequently be occupied with this work.

### DISCLOSURE OF THE INVENTION

The present invention was devised with this situation in view, an object thereof being to ensure that management of a plurality of sensors situated in distant locations can be carried out in a simple fashion, and to enable data obtained from these sensors to be used readily.

The information processing system according to a first aspect of the present invention is characterized in that a first information processing device comprises: measuring means for measuring the remaining amount of the prescribed material; and transmitting means for transmitting data relating to the remaining amount as measured by the measuring means, to a second information processing device; the second information processing device comprises: transferring means for receiving data relating to the remaining amount as transmitted by the transmitting means and transferring same to a third information processing device; and the third information processing device comprises: receiving means for receiving data relating to the remaining amount as transferred by the transferring means; and predicting means for predicting the point in time at which the remaining amount of the prescribed material will become zero, by using the data relating to the remaining amount received by the receiving means.

The second information processing device may be connected to the first information processing device by means of a local area network, in addition to being connected to the third information processing device by means of a wide area network.

The transfer of the data by the transferring means may be carried out at a prescribed cycle, this cycle being established on the basis of the rate of change of the remaining amount as measured by the measuring means.

The information processing method for the information processing system according to the first aspect of the present invention is characterized in that the information processing method for the first information processing device comprises: a measuring step for measuring the remaining amount of the prescribed material; and a transmission control step for controlling the transmission of data relating to the remaining amount as measured by means of the processing in the measuring step, to the second information processing device; the information processing method for the second information processing device comprises: a transfer control step for controlling the reception of data relating to the remaining amount, the transmission of which is controlled by means of the processing in the transmission control step, and controlling the transfer of the data to the third information processing device; and the information processing method for the third information processing device comprises: a reception control step for controlling the reception of data relating to the remaining amount, the transfer of which is controlled by means of the processing in the transfer control step; and a predicting step for predicting the point in time at which the remaining amount of the prescribed material will become zero, by using the data relating to the remaining amount, the reception of which is controlled by means of the processing in the reception control step.

The information processing device according to the first aspect of the present invention is characterized in comprising: receiving means for receiving data relating to the remaining amount of a prescribed material, as obtained by means of another information processing device; predicting means for predicting the point in time at which the remaining amount of the prescribed material will become zero, by using the data relating to the remaining amount received by the receiving means; and replenishing means for implementing processing relating to replenishment of the material, on the basis of the prediction made by the predicting means.

The information processing device may further comprise: acquiring means for acquiring positional information for a vehicle performing delivery of the material, in order to carry out replenishment of the material; the replenishing means calculating the point in time at which the vehicle is to deliver the material, by using the point in time at which the remaining amount of the prescribed material will become zero as predicted by the predicting means, and the positional information acquired by the acquiring means.

If the difference between the remaining amount at the point in time at which replenishment of the material was carried out, and the remaining amount determined from the data relating to the remaining amount as received by the receiving means, is taken to be remaining amount difference W1, the time period required for this remaining amount difference W1 to arise is taken to be time period T1, and the remaining amount determined from the data relating to the remaining amount as received by the receiving means is taken to be remaining amount W2, then the predicting means may calculate the time period T2 from the current time T until the point in time at which the remaining amount of the material will become zero by calculating T1×(W2/W1), and may predict the point in time at which the remaining amount of the material will become zero by adding the time period T2 thus calculated to the current time T; this prediction being made without including the time period required for the change in the remaining amount difference W1 to arise, in the time period T1, if the amount of change is within a prescribed range.

The information processing method for the information processing device according to the first aspect of the present invention is characterized in comprising: a predicting step for predicting the point in time at which the remaining amount of a prescribed material will become zero, by using data relating to the remaining amount of the prescribed material as obtained by means of another information processing device; and a replenishing step for executing processing relating to replenishment of the material, on the basis of the prediction made in the predicting step.

The information processing system according to a second aspect of the present invention is characterized in that a first information processing device comprises: acquiring means for acquiring measurement results as measured by sensors; storing means for storing an ID assigned to the first information processing device itself; first transmitting means for transmitting the measurement results acquired by the acquiring means, and the ID stored by the storing means, to a second information processing device; and setting means for receiving data from the second information processing device and making settings on the basis of the data thus received; the second information processing device comprises: processing means for receiving the measurement results and the ID as transmitted by the first transmitting means, and processing the measurement results on the basis of setting items established with respect to the processing of the measurement results, as stored in association with the ID; supplying means for supplying the measurement results processed by the processing means to the third information processing device; and second transmitting means for transmitting data relating to the settings of the first information processing device from the third information processing device, to the first information processing device; and the third information processing device comprises: display control means for controlling the display of the measurement results supplied by the supplying means; and third transmitting means for transmitting data relating to settings for the first information processing device and data relating to setting items established with respect to the measurement results in the processing means, to the second information processing device.

The information processing device according to the second aspect of the present invention is characterized in comprising: acquiring means for acquiring measurement results measured by sensors; storing means for storing an ID assigned to the information processing device itself; transmitting means for transmitting the measurement results acquired by the acquiring means and the ID stored in the storing means, to another device; and setting means for receiving data from the other device and making settings on the basis of the data thus received.

The ID may be a URL.

The transmitting means may append authentication data to the measurement results and the ID, and then transmit same to the other device.

The information processing method for the information processing device according to the second aspect of the present invention is characterized in comprising: an acquiring step for acquiring measurement results measured by means of sensors; a transmission control step for controlling the transmission of the measurement results acquired by means of the processing in the acquiring step, and an ID assigned to the device in question, to another device; and a setting step for controlling reception of data from the other device and making settings on the basis of the data received by means of this control.

The information processing device according to a third aspect of the present invention is characterized in comprising: first receiving means for receiving measurement results measured by means of sensors and transmitted by a first device, and an ID serving to identify the first device; processing means for processing the measurement results received by the first receiving means, on the basis of settings items established with respect to the processing of the measurement results and stored in association with the ID; second receiving means for receiving data relating to the settings items and data relating to the settings of the first device, from a second device; transmitting means for transmitting data relating to the settings of the first device as received by the second receiving means, to the first device; and supplying means for supplying the measurement results processed by the processing means, to the second device.

The processing means may compare a measurement result received by the first receiving means with an upper limit value or lower limit value established as one of the setting items, and if the comparison result indicates that the measurement result is equal to or greater than the upper limit value, or that the measurement result is equal to or lower than the lower limit value, then it may transmits an electronic mail indicating this fact, together with an attached electronic signature, to an established electronic mail address.

The information processing method for the information processing device according to the third aspect of the present invention is characterized in comprising: a first reception control step for controlling the reception of measurement results as measured by means of sensors and transmitted by a first device, and an ID serving to identify the first device; a processing step for processing the measurement results, the reception of which is controlled by means of the processing in the first reception control step, on the basis of settings items established with respect to the processing of the measurement results and stored in association with the ID; a second reception control step for controlling reception of data relating to the settings items and data relating to the settings of the first device, from a second device; a transmission control step for controlling transmission of data relating to the settings of the first device, the reception of which is controlled by means of the processing in the second reception control step, to the first device; and a supplying step for supplying the measurement results processed by means of the processing in the processing step, to the second device.

According to the information processing system and information processing method according to a first aspect of the present invention, since a first information processing device measures the remaining amount of a prescribed material and transmits that data to a second information processing device, the second information processing device receives data relating to the remaining amount from the first information processing device and transmits this data to a third information processing device, and the third information processing device receives data relating to the remaining amount and predicts the point in time at which the remaining amount of the prescribed material will become zero, by using this data, it is therefore possible to manage the remaining amount of a material managed at a distant position, and it is also possible to carry out replenishment in a highly efficient manner, at the time that the remaining amount of material becomes zero.

According to the information processing device and information processing method of the first aspect of the present invention, since the point in time at which the remaining amount of a prescribed material will become zero is predicted by using data relating to the remaining amount of the prescribed material as acquired by means of another information processing device, then delivery of the material, for example, can be carried out in a highly efficient manner, on the basis of this prediction.

According to the information processing system of the second aspect of the present invention, since a first information processing device transmits the measurement results measured by sensors, and an ID assigned to itself, to a second information processing device, and receives data from the second information processing device and makes settings on the basis of the data thus received, and since the second information processing device processes the received measurement results on the basis of settings items established with respect to the measurement results processed and stored in association with the aforementioned ID, and transmits data relating to settings for the first information processing device from a third information processing device, to the first information processing device, and since the third information processing device transmits data relating to settings in the first information processing device, and data relating to settings items established with respect to the measurement results, to the second information processing device, it is therefore possible to perform management of the sensors in a simple fashion at the third information processing device, and furthermore, it is also possible to monitor and manage the measurement results obtained by the sensors, in a simple fashion.

According to the information processing device and information processing method of the second aspect of the present invention, since the measurement results measured by sensors are transmitted, together with an ID assigned to the transmitting device, to another device, and since data from the other device is received and settings are made on the basis of the data thus received, it is possible to perform management of the sensors by means of the other device, and it is also possible for a user to carry out processes, such as managing the sensors, or monitoring the measuring results obtained from same, or the like, in a simple fashion.

According to the information processing device and information processing method of the third aspect of the present invention, since an ID for identifying the first device is received with the measurement results measured by the sensor and transmitted by the first device, the measurement results thus received being processed on the basis of settings items established with respect to the processing of the measurement results and stored in association with the ID, and since data relating to the settings items and data relating to the settings of the first device is received from the second device and the data relating to the settings of the first device thus received is transmitted to the first device, whilst the processed measurement results are supplied to the second device, then at the second device located on the user side, it is possible to manage the first device, and it is also possible for the user to carry out processes, such as monitoring the measurement results acquired by the first device, and the like, in a simple fashion.

### BRIEF DESCRIPTION OF THE DRAWINGS

FIG. 1 is a diagram showing the composition of one embodiment of an information processing system to which the present invention is applied;

FIG. 2 is a diagram for illustrating an example of the composition of a group 4 in FIG. 1;

FIG. 3 is a diagram for illustrating an example of the composition of a sensor 12 in FIG. 2;

FIG. 4 is a diagram showing an example of the external composition of the controller 13 in FIG. 2;

FIG. 5 is a diagram showing an example of the internal composition of the controller 13 in FIG. 2;

FIG. 6 is a flowchart illustrating the processing performed by the controller 13 in FIG. 2;

FIG. 7 is a flowchart illustrating the processing performed by the data center 2 in FIG. 1;

FIG. 8 is a diagram illustrating the calculation of a predicted value;

FIG. 9A is a diagram illustrating the calculation of a predicted value;

FIG. 9B is a diagram illustrating the calculation of a predicted value;

FIG. 9C is a diagram illustrating the calculation of a predicted value;

FIG. 10 is a diagram showing an example of the composition of a personal computer 30;

FIG. 11 is a flowchart for illustrating the processing implemented by the delivery center 3 in FIG. 1;

FIG. 12 is one example of a screen displayed on a display monitor;

FIG. 13 is a diagram for illustrating delivery;

FIG. 14 is a diagram showing a further example of the composition of an information processing system to which the present invention is applied;

FIG. 15 is a diagram showing an example of the composition of a personal computer 101 in FIG. 14;

FIG. 16 is a flowchart illustrating processes performed by a user;

FIG. 17 is a diagram showing one example of a screen displayed on a display 181;

FIG. 18 is a diagram showing one example of a screen displayed on a display 181;

FIG. 19 is a flowchart illustrating the operation of the system illustrated in FIG. 14;

FIG. 20 is a diagram showing one example of a screen displayed on a display 181; and

FIG. 21 is a flowchart illustrating the processing implemented by the data center 2 in FIG. 14.

### BEST MODE FOR CARRYING OUT THE INVENTION

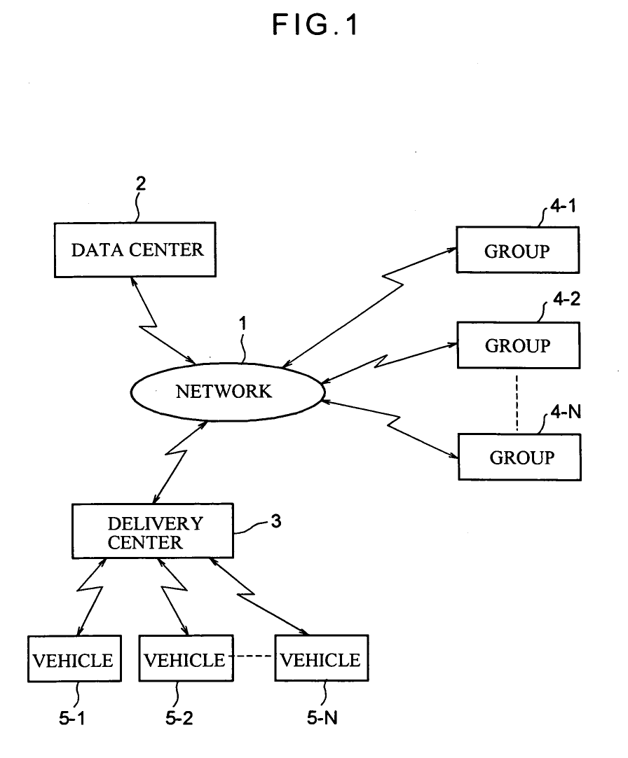

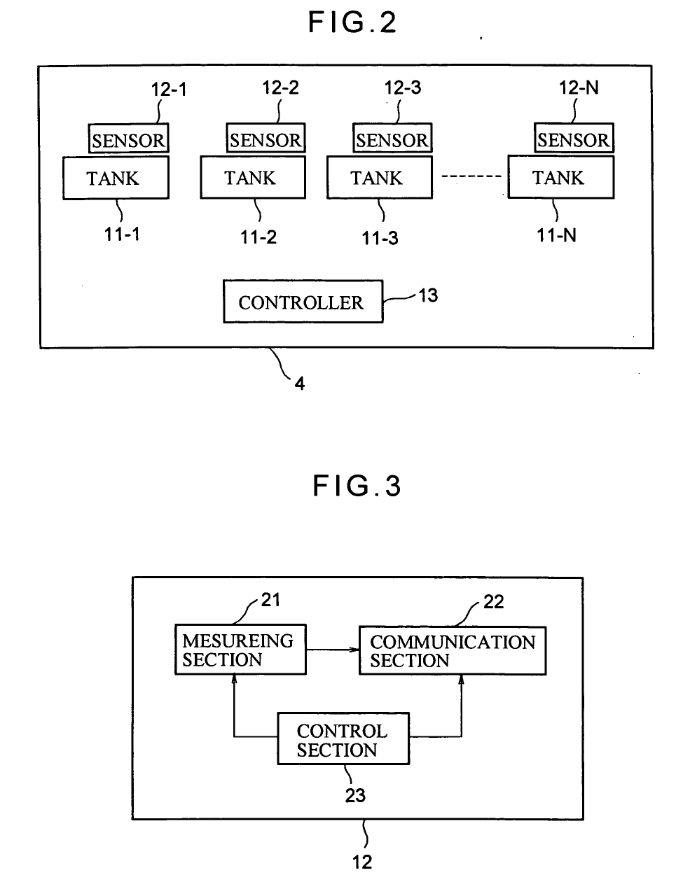

Below, an embodiment of the present invention is described with reference to the drawings. FIG. 1 is a diagram showing the composition of one embodiment of an information processing system in which the present invention is applied. A data center 2, delivery center 3, and groups 4-1 to 4-N are connected to a network 1. The network 1 is constituted by the Internet, a LAN (Local Area Network), or the like, and it may comprise a wireless setup or a wired setup. The data center 2 receives data from a controller 13 (FIG. 2) provided respectively in each of the groups 4-1 to 4-N described hereinafter, and processes this data.

In the following description, where there is no need to distinguish separately between the groups 4-1 to 4-N, the description shall refer simply to the group 4. A similar approach is also used when describing other devices.

The delivery center 3 instructs delivery of a prescribed material to vehicles 5-1 to 5-N, by using the data processed by the data center 2. The communication between the delivery center 3 and the vehicles 5 is carried out by means of a method using portable telephones, or a method using radio communications, or the like. Each of the vehicles 5 is provided with a device, such as a GPS (Global Positioning System), or the like, which measures the position of that vehicle, and by enabling the delivery center 3 to manage this positional information, it becomes possible for the delivery center 3 to manage the positions of the respective vehicles 5.

In FIG. 1, only one data center 2 and one delivery center 3 are respectively illustrated, but it is of course possible for there to be a plurality of each.

As illustrated in FIG. 2, a group 4 is constituted by a plurality of tanks 11-1 to 11-N, sensors 12-1 to 12-N connected respectively to these tanks 11-1 to 11-N, and a controller 13 which controls these sensors 12-1 to 12-N. Each tank 11 is situated, for example, in a respective household, factory, or the like. If the tanks 11 are situated in respective households, then a group 4 is constituted by a plurality of tanks 11 situated in households. If the tanks 11 are situated in factories, or the like, then a group 4 is constituted by a plurality of tanks 11 situated in these factories. If the tanks 11 are situated in respective households, then a group 4 is constituted by a plurality of tanks 11 situated in households.

Each sensor 12 is connected to a tank 11 and measures the remaining amount of material contained in the tank 11 to which it is connected. The data thus measured is supplied to a controller 13. The controller 13 and the sensors 12-1 to 12-N are connected to a network constituted by a LAN, forming a configuration whereby data can be transmitted and received mutually therebetween. The communications between the sensors 12 and the controller 13 may be based on wireless communications, or they may be based on wired communications. The controller 13 also has the function of communicating with the other devices connected to the network 1, such as the data center 2, for example.

FIG. 3 shows an example of the composition of a sensor 12. The sensor 12 is constituted by a measuring section 21 for measuring the remaining amount of material in the tank 11, a communications section 22 for transmitting data relating to the remaining amount measured by the measuring section 21, to the controller 13, and a control section 23 for controlling the measuring section 21 and the communications section 22.

The sensor 12 used may be a floating type sensor, pressure type sensor, weight type sensor, electrostatic capacitance type sensor, ultrasonic level sensor, wireless radio type sensor, or the like, and a type of sensor which is suited to measuring the remaining amount of material contained in the tank 11 should be used.

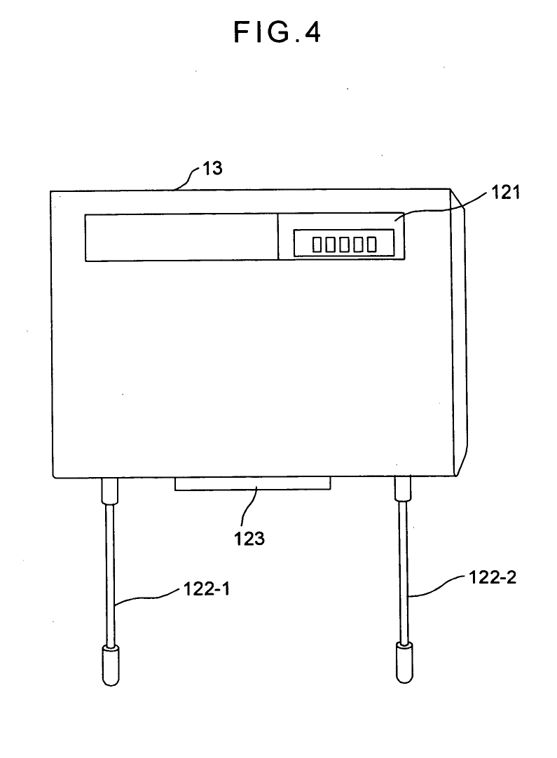

FIG. 4 is a diagram showing the composition of the external appearance of a controller 13. The controller 13 is provided with a display section 121 which performs a display indicating the status of the controller 13, such as whether the power is switched on or off, for example, and with antennas 122-1 and 122-2 for communicating with the data sensor 2 via the network 1. The controller 13 is also provided with an interface 123 to which sensors 12 are connected.

The controller 13 can be connected to sensors 12 of a type corresponding to the object that is to be measured, and it can also be connected to a plurality of sensors 12. When a plurality of sensors 12 are connected, these sensors 12 may be the same, or they may be different.

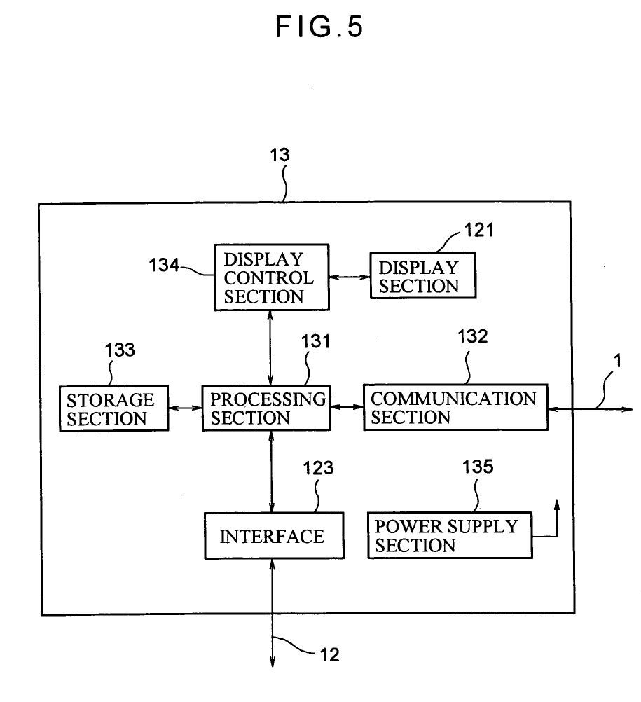

FIG. 5 is a diagram showing an example of the internal composition of a controller 13. The interface 123 of the controller 13 is connected to a sensor 12, and it performs processing, such as converting data transmitted and received between the sensor 12 and a processing section 131. The processing section 131 transmits data from the sensor 12 as input by means of the interface 123, as and when necessary, to the data center 2 from a transmission section 132, via the network 1.

The communications section 132 also receives data from the data center 2 as transmitted via the network 1, and supplies this data to the processing section 131. The processing section 131 executes processing, such as storing the supplied data in a storage section 133, as and when necessary. Data, such as programs required in order for the processing section 131 to execute processing, are stored in the storage section 133.

A display control section 134 controls the display section 121 on the basis of the instructions from the processing section 131. A power supply section 135 supplies a power voltage from a primary cell or secondary cell, or from an external AC power source, and performs controls in such a manner that the power voltage thus supplied is distributed to the respective sections of the controller 13.

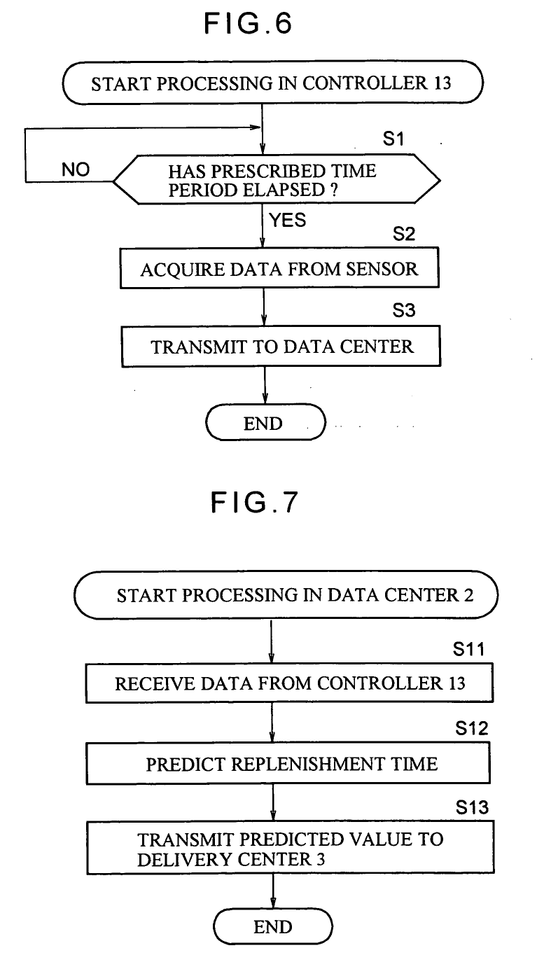

Next, the operation of the controller 13 illustrated in FIG. 5 is described with reference to the flowchart in FIG. 6. At step S1, the processing section 131 of the controller 13 judges whether or not a prescribed time period has elapsed since data was transmitted in the processing at step S3 of the previous operation. The prescribed time period is established in accordance with the rate of usage (amount of change) of the material stored in the tanks 11. For example, in cases where the material stored in the tanks 11 diminishes at a relatively quick rate, then the prescribed time period is set to a short time (for example, every 10 minutes), whereas if it diminishes at a relatively slow rate, then the prescribed time period is set to a longer time (for example, once a day).

At step S1, if it is judged that a time period corresponding to the prescribed time period thus established has elapsed since the previous set of data was transmitted, then the procedure advances to step S2, where the processing section 131 of the controller 13 acquires data relating to the amount of material remaining in a tank 11, as obtained by a sensor 12, by means of the interface 123. At step S3, the data thus acquired is transmitted by the transmission section 132 to the data center 2, via the network 1. The data transmitted at this time consists of data for identifying the sensor 12 and data relating to the remaining amount as obtained by the sensor 12, these data being mutually associated.

Next, the operation of the data center 2 is described with reference to the flowchart in FIG. 7. At step S11, the data center 2 receives the data transmitted by the controller 13 in step S3 (FIG. 6). Thereupon, at step S12, the data center 2 uses the data thus received to predict a time point at which the remaining amount in the tank 11 will become zero, in other words, the date and time at which replenishment will become necessary.

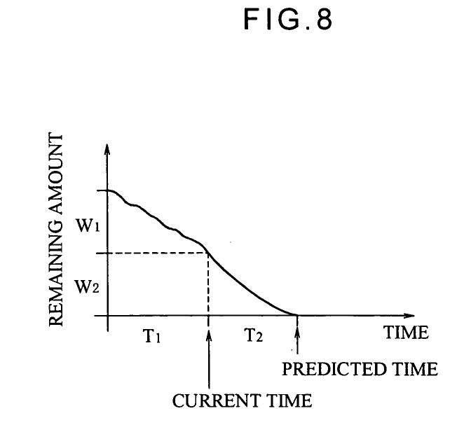

In order to implement replenishment in the most efficient manner, the actual replenishment of the material should be carried out at the time that the remaining amount in the tank 11 has become zero. Therefore, the time at which the remaining amount in the tank 11 will become zero is predicted. This prediction process will now be described. FIG. 8 is a graph showing the change in the remaining amount in the tank 11, based on the data obtained by the sensor 12. The horizontal axis indicates the elapsed time, and the vertical axis indicates the remaining amount.

For example, as illustrated in FIG. 8, the relationship between time and the remaining amount is a primary functional relationship. In other words, it can be considered that the material is used, and hence diminishes, at virtually a uniform rate. In FIG. 8, the difference in the remaining amount between the time at which the material was replenished (in other words, when the tank 11 was in a full state) and the current time (namely, the capacity of the tank 11 minus the remaining amount in the tank 11 at the current time) is taken to be remaining amount difference W1, the difference in the remaining amount between the current time until the time at which the remaining amount will become zero (namely, the remaining amount at the current time) is taken to be remaining amount difference W2, the time period from the time at which the material was replenished until the current time is take to be time period T1, and the time period from the current time until the time at which the remaining amount will become zero is taken to be time period T2.

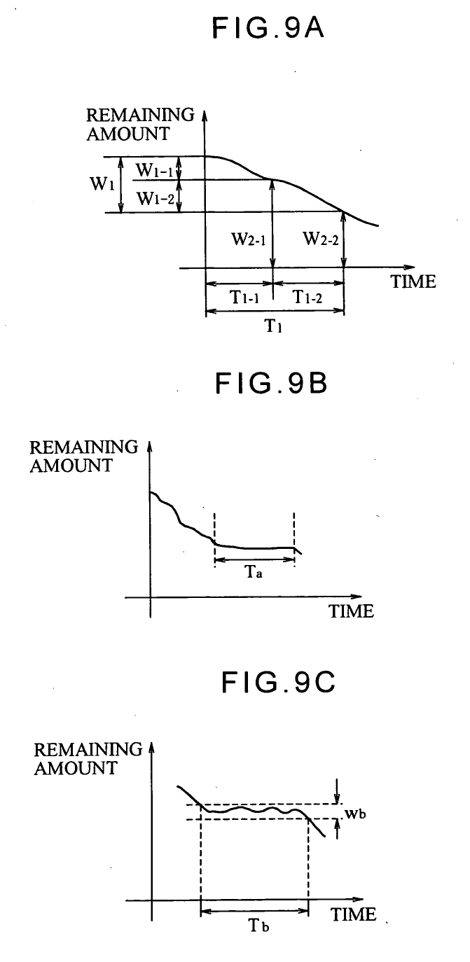

As shown in FIG. 9A, each time data is received, the remaining amount difference W1 is determined by means of cumulative addition, in such a manner that the current remaining amount difference W1-2 is added to the previous remaining amount difference W1-1. As shown in FIG. 9A, the time period T1 is also determined by means of cumulative addition, each time data is received, in such a manner that the current time period T1-2 is added to the previous time period T1-1. The following relationship, equation (1), can be established for these values.

T1:W1=T2:W2 (1)

The following equation (2) can be obtained from the relationship in equation (1).

T2=T1×(W2/W1) (2)

The time period T2 can be derived from equation (2). Consequently, the date and time at which the remaining amount of material will become zero can be determined by adding the time period T2 to the current date and time.

In this way, it is possible to predict the date and time at which the remaining amount of material in the tank 11 will become zero, but situations can be conceived, however, where, for example, the material in a tank 11 situated in a factory does not diminish, because the factory is not operating, or where communications cannot be performed between the controller 13 and the data center 2, for any particular reason, or where the data center 2 has not been able to acquire data because the sensor 12 is not operating. In cases such as these, the graph will be such as that illustrated in FIG. 9B. In FIG. 9B, the time period Ta indicates the time period during which the remaining amount difference W1 is 0.

If the time period T1 includes a time period Ta of this kind, then accurate prediction will not be possible, and therefore a threshold value is established for the time period. Each time data is received, the time period T1 is determined by adding the time interval with respect to the last time at which data was received, but if the interval to be added is equal to or greater than a threshold value, the time period T1 is calculated without adding this time interval. In this way, processing is achieved whereby a time period such as time period Ta is not included in the prediction operation.

Moreover, as shown in FIG. 9C, it can also be conceived that there will be situations where the obtained figures are not uniform, within the range of the remaining amount difference Wb, even though the actual amount of the material has not changed, due to error in the sensors 12, noise in the communications path, or the like. If a remaining amount difference Wb of this kind is included in the remaining amount difference W1, then it will not be possible to make an accurate prediction, and therefore a threshold value is established for the remaining amount difference.

If the remaining amount difference W1 is less than the remaining amount difference Wb established as a threshold value for the remaining amount difference, then the time period Tb during which this remaining amount difference Wb arose is not included in the time period T1 (it is not added). By implementing corrections of this kind, it is possible to make an accurate prediction.

Returning to the description of the flowchart in FIG. 7, at step S12, when the prediction of the replenishment time has been completed, the information relating to this prediction (hereinafter, referred to as “prediction value”, for the sake of convenience,) is then transmitted to the delivery center 3 at step S13. The delivery center 3 uses the prediction value thus supplied to issue instructions to a vehicle 5, in such a manner that replenishment of the material is carried out in a highly efficient way.

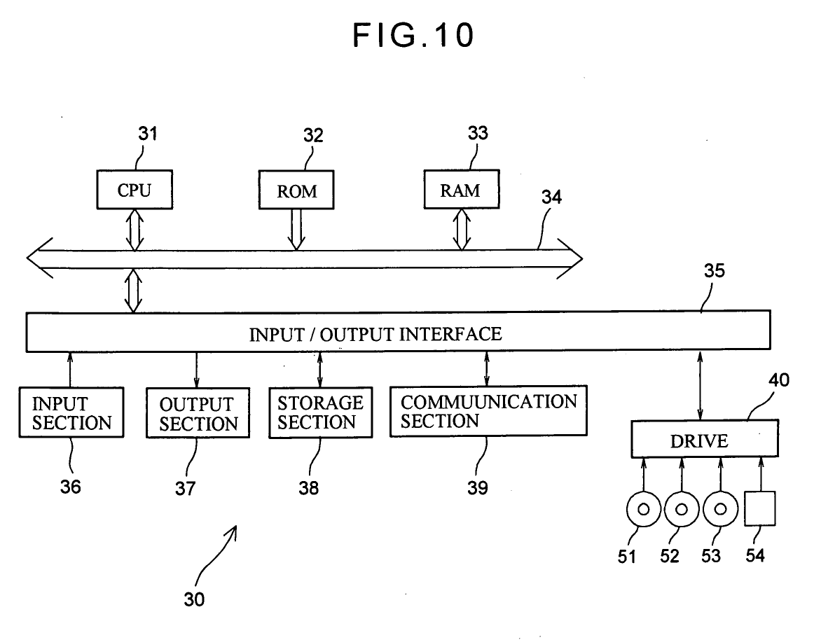

The delivery center 3 is connected to the network 1, and comprises a device having a function for sending and receiving data, such as a personal computer, for example. FIG. 10 shows an example of the internal composition of a personal computer 30. The CPU (Central Processing Unit) 31 of the personal computer 30 executes various processes in accordance with a program stored in a ROM (Read Only Memory) 32. The data, programs, and the like, required by the CPU 31 in order to execute various types of processing, are stored as appropriate in the RAM (Random Access Memory) 33. The CPU 31, ROM 32 and RAM 33 are mutually connected via a bus 34. An input/output interface 35 is also connected to this bus 34. An input section 36 consisting of a keyboard, mouse, or the like, is connected to the input/output interface 35, which transmits signals input to the input section 36, to the CPU 31. Moreover, an output section 37 constituted by a display, speakers, and the like, is also connected to the input/output interface 35.

Furthermore, a storage section 38 constituted by a hard disk, or the like, and a communications section 39 for sending and receiving data to and from other devices (such as the controller 13, for example), via the network 1, are also connected to the input/output interface 35. A drive 40 is used for reading out data from, or reading data to, a storage medium, such as a magneto-optical disk 51, an optical disk 52, an opto-magnetic disk 53, a semiconductor memory 54, or the like.

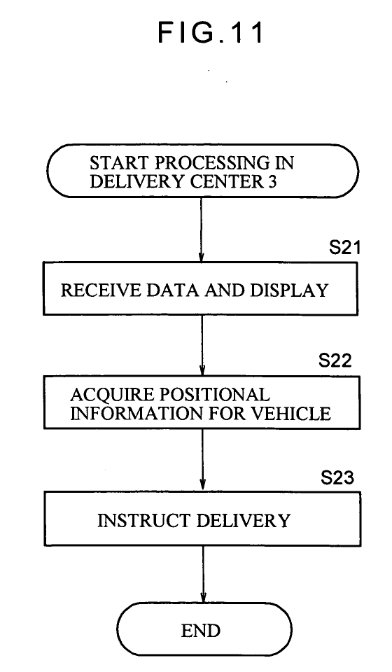

The processing carried out by the personal computer 30 having this composition is now described with reference to the flowchart in FIG. 11. At step S21, the personal computer 30 connects to the data center 2, via the network 1, in accordance with an instruction input by the user, and it receives data from the data center 2. The CPU 31 causes a prescribed screen to be shown on a display 61 of the output section 37, on the basis of the data received in this manner.

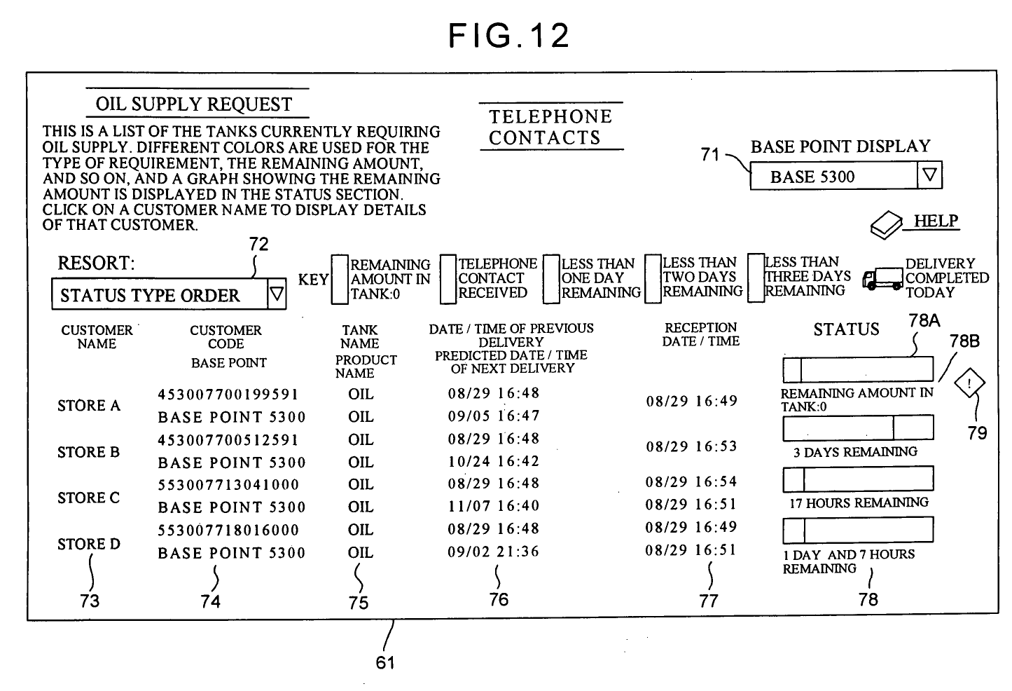

FIG. 12 is a diagram showing one example of a screen shown on a display 61. The screen shown in FIG. 12 is a display example relating to an oil supply request, and this oil supply request screen displays information relating to tanks 11 which have been judged to require an oil supply (replenishment) at a near date, on the basis of the prediction values. On the upper right-hand side of the display 61, there is displayed a base point selecting section 71 for selecting, from a pull-down menu, the group 4 (base point at which tanks 11 are situated) for which information on the remaining amounts in the tanks 11, and the like, is to be displayed. On the upper left-hand side of the display 61, there is a display conditions selection section 72 for selecting the order in which information is to be displayed.

Beneath the display conditions selection section 72, there is displayed a name display section 73 for displaying the names registered upon agreement of a contract for shops, households, and the like, belonging to the base point selected by means of the base point selection section 71. A customer code corresponding to the name displayed in the name display section 73, and the name of the base point, are displayed in a code display section 74. Moreover, there is also displayed a material name display section 75 for indicating the material that is managed at the location corresponding to the displayed name. In FIG. 10, “fuel oil” is displayed as the material name.

A date and time display section 76 displays the date and time at which the last oil supply was made (in this case, since the material is fuel oil, the term oil supply is displayed), and the date and time at which it is predicted that the next oil supply will be required. To the right-hand side thereof, a reception date and time display section 77 is displayed, which indicates the date and time at which the data center 2 received data from the controller 13.

In a status display section 78, there are shown a level meter 78A for indicating the remaining amount in each respective tank 11, and a prediction value display section 78B for indicating the prediction value. A warning display section 79 is displayed at a position corresponding to any tank 11 for which the prediction value shown in the prediction value display section 78B is zero, or any tank 11 for which it is judged that oil supply is required. The warning display section 79 may be devised in such a manner that it is also displayed, for instance, in cases where it has been judged that an abnormality of some kind has occurred in a tank 11.

The position marked by the indictor needle on the level meter 78A is based on the prediction value displayed by the prediction value display section 78B. If the indicator needle displayed by the level meter 78A is positioned towards the right-hand side in the diagram, then this shows that the remaining amount in the tank 11 corresponding to that level meter 78A is high. There will be cases where, even if the indicator needle shown by the level meter 78A is placed at the same position, the prediction value displayed by the prediction value display section 78B is different. This is because, the prediction value is calculated for each tank 11 by means of the method described above.

More specifically, even if there are tanks 11 which have the same remaining amount, predictions will not be made which indicate that they have to be replenished at the same date and time. This type of operation cannot be achieved in a method which instructs replenishment whenever the remaining amount has reached or fallen below a threshold value. In the present embodiment, since a prediction is made for each tank 11 by means of the method described above, replenishment can be carried out at suitable timing.

Display keys is shown to the right-hand side of the display conditions selection section 72. The name display section 73 through to the status display section 78 are displayed in different colors, in accordance with the colors displayed in the respective keys.

A user is able to monitor a screen of this kind by means of a prescribed browser, for example. The screen shown in FIG. 12 illustrates one example, but neither the information displayed, nor the display configuration adopted are limited to those illustrated.

Returning to the description of the flowchart in FIG. 11, when data is received and a screen is displayed on the basis of this data at step S21, the personal computer 30 then acquires information relating to the positions of the vehicles 5, at step S22. As stated previously, each vehicle 5 is provided with a device that is capable of measuring the position of that vehicle, such as a GPS device, or the like. The information relating to the position of the vehicle as obtained by this device, is acquired by the personal computer 30, from each vehicle 5.

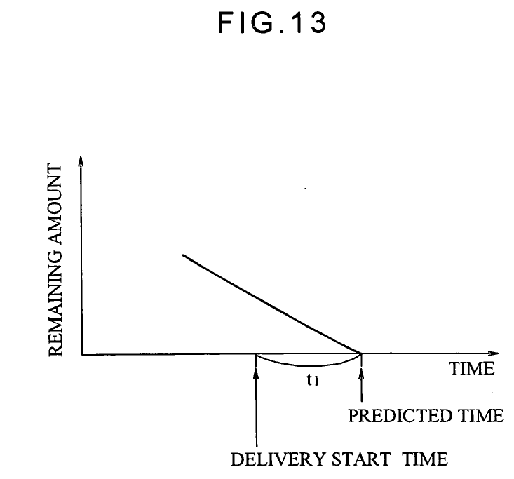

Thereupon, at step S23, a delivery instruction is issued, on the basis of the positional information thus acquired. The delivery instruction is made by utilizing the prediction value relating to the date and time at which the remaining amount in the tank 11 will become zero, and the positional information of the vehicles 5. To describe this with reference to FIG. 13, the time period t1, required for the vehicle 5 to travel to the position at which the tank 11 to be replenished is situated, is calculated. This time period t1 is calculated by using the positional information for the vehicle 5 and the positional information for the tank 11.

The date and time at which the delivery to that tank 11 is to be started is calculated by subtracting the time period t1 from the date and time at which it is predicted that the remaining amount in the tank 11 will become zero. If delivery is started at the date and time calculated in this way, then it can be supposed that the remaining amount in the tank 11 will have become relatively low and will be approaching zero, by the time that the vehicle 5 arrives at the place where the tank 11 is situated, in other words, by the time that replenishment is carried out.

By carrying out replenishment at a time (predicted time) where the remaining amount in the tank 11 becomes zero, in this way, the highest efficiency is achieved in delivery. A delivery instruction is issued to a vehicle 5 that is capable of making a delivery of this kind. This delivery instruction may be issued by means of processing data in the data center 2 and then supplying the results of this processing to the delivery center 3, or it may be issued by carrying out processing in the personal computer 30 in the delivery center 3. Furthermore, it may also be issued by a user who is monitoring a screen such as that illustrated in FIG. 12.

In this way, by monitoring the remaining amount in the tank 11, predicting the date and time at which the remaining amount will become zero, and establishing a delivery plan in accordance with this prediction and the positional information of the vehicle 5, it is possible to carry out replenishment of the material at a high level of efficiency.

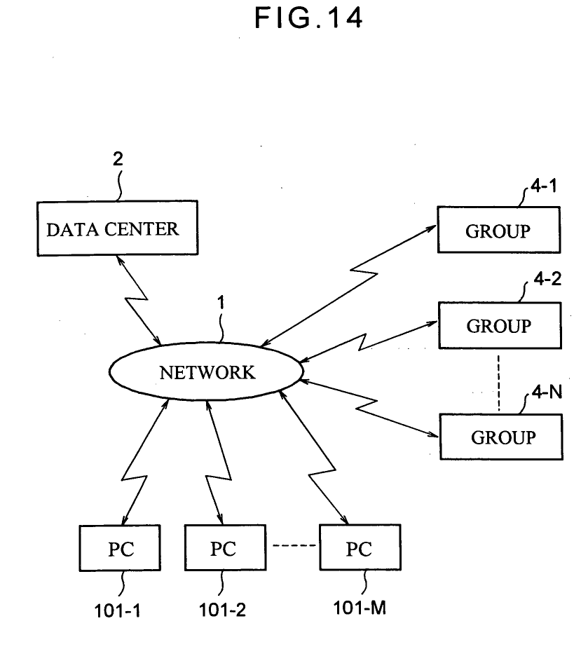

Next, a further compositional example of an information processing system to which the present invention is applied will be described with reference to FIG. 14. In FIG. 14, corresponding reference numerals are applied to parts which correspond to those in FIG. 1, and description thereof is omitted in order to avoid repetition.

In the example in FIG. 14, PCs (personal computers) 101-1 to 101-M are connected to the network 1, instead of to the delivery center 3. In the following description, where there is no need to distinguish separately between the PCs 101-1 to 101-M, the description shall refer simply to the PC 101.

The PC 101 is a computer situated on the user side for managing a controller 13 provided in the group 4, and it carries out processing using data from the data center 2 obtained by processing data received from the controller 13.

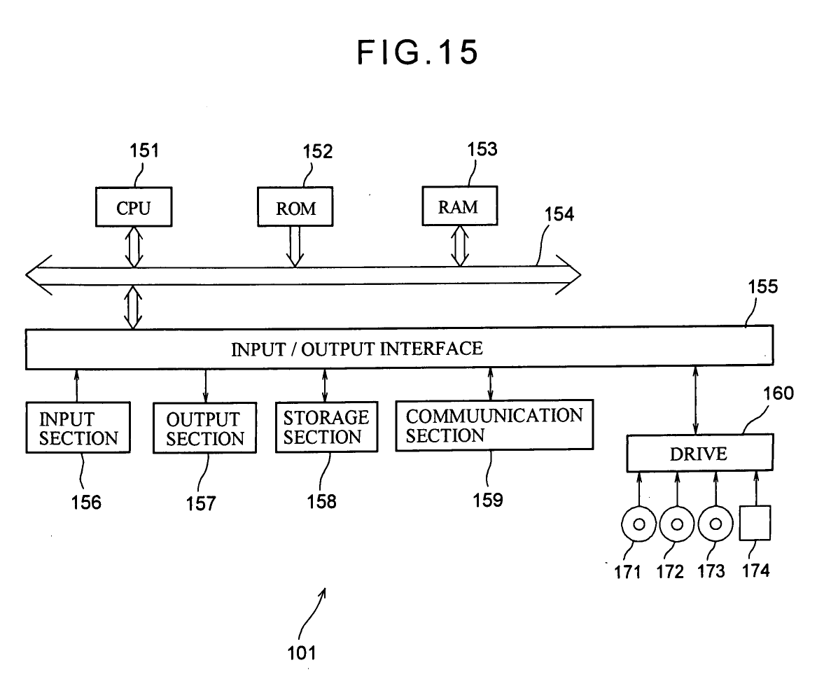

FIG. 15 shows an internal compositional example of a PC 101. In FIG. 15, the elements from the CPU 151 to the semiconductor memory 174 have essentially the same functions as the CPU 31 of the personal computer 30 to the semiconductor memory 54 in FIG. 10, and therefore further description thereof is omitted here.

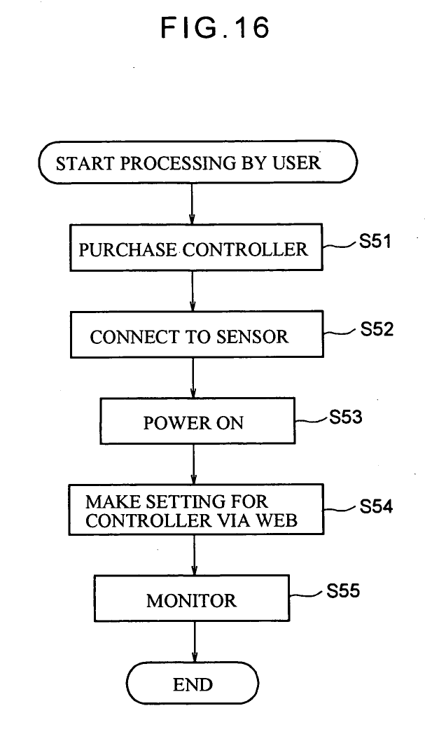

Next, the operations carried out by the user with respect to the controller 13 will be described with reference to the flowchart in FIG. 16. At step S51, the user purchases the controller 13. At step S52, the user connects the controller 13 thus purchased to a sensor 12. The sensor 12 is positioned in such a manner that it can carry out the measurements required by the user. Moreover, in addition to connecting one sensor 12 to one controller 13, as described above, it may also arise that a plurality of sensors 12 are connected to one controller 13. Desirably, these connections are devised so as to be straightforward to implement, by simply plugging in a cable, for instance.

At step S53, the user switches the power of the controller 13 to ON. A switch (not illustrated) for changing the on and off status of the power supply is provided on the controller 13, and the user operates this switch at step S53.

Thereupon, the processing at step S54 is carried out by means of a PC 101 situated at a location that is distant from the location at which the sensor 12 and controller 13 are situated. Of course, the PC 101 may also be situated in a position near to the sensor 12 and controller 13, but by providing the controller 13 according to the present embodiment with a communications section 132, a composition is achieved wherein data can be transmitted and received, to and from a PC 101, or the like, situated at a remote location, and therefore, the user is able to execute the processing in step S54 at a PC 101 that is situated at a remote location.

In step S54, the user causes the PC 101 to connect to the data center 2 by means of the network 1. By making this connection, a state is achieved wherein data can be transmitted and received between the PC 101 and the data center 2. The transmission and reception of data between the PC 101 and the data center 2 is conducted by means of a Mosaic-type Web browser. At step S54, the user makes settings relating to the sensor 12 and the controller 13, as well as settings relating to processing of the data that is obtained by the sensor 12 and transmitted to the data center 2 via the controller 13.

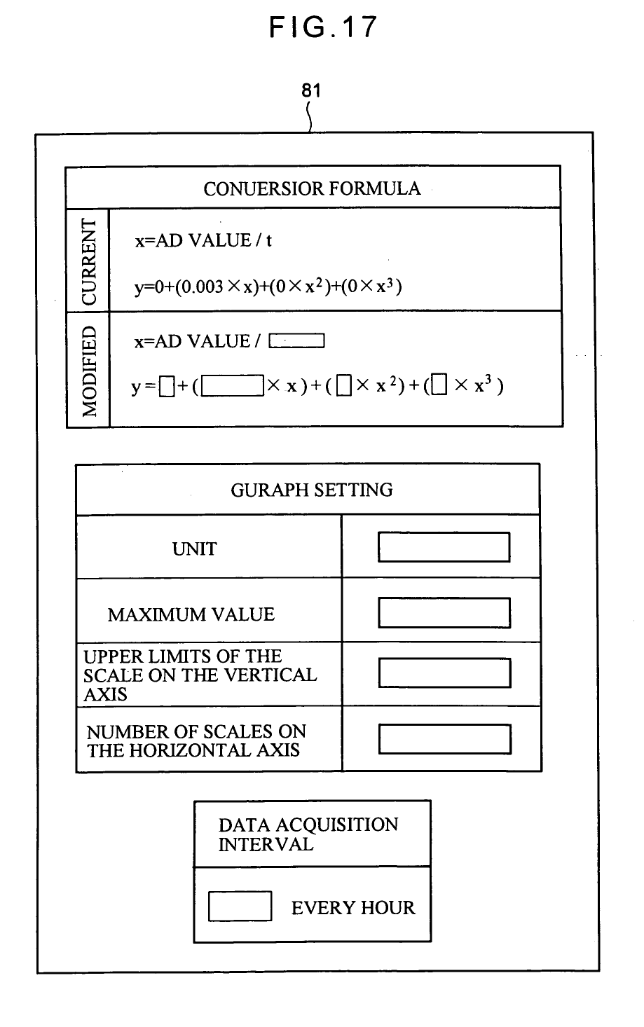

FIG. 17 shows one example of a settings screen for performing various settings, as displayed on the display 181 forming the output section 157 of the PC 101 at step S54. The items which are set on the settings screen include, for example, conversion formula, graph settings, data acquisition intervals, and the like, as illustrated in FIG. 17. The conversion formula is an equation for determining what type of value the data acquired by means of the sensor 12 should be converted into for display on the screen, for example, when displaying the data as a graph, or the like. The example shown in FIG. 17 relates to a case where the conversion formula can be set in a range from a primary to a tertiary function.

It is also possible to make graph settings for cases where the data converted by the conversion formula is displayed in the form of a graph. The graph settings that may be set include the units, maximum values, upper limits of the scale on the vertical axis, number of scales on the horizontal axis, and the like. The setting of the data acquisition interval means setting the number of hours' interval at which the data acquired by the sensor 12 is to be transmitted to the data center 2. In FIG. 17, this interval is stated in hours, but it is also possible to use other units, such as days, minutes, seconds, or the like.

Moreover, it is also possible to adjust the interval at which the sensor 12 obtains data. The data obtained by the sensor 12 may be stored temporarily in a storage section 133 of the controller 13, in such a manner that it is then transmitted to the data center 2, each time an established time period elapses. Desirably, these settings are devised in such a manner that they can all be made by the user.

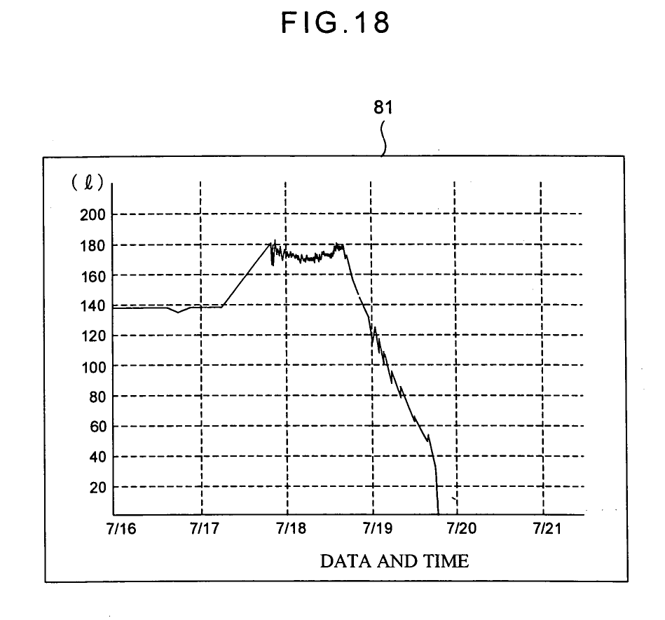

In this way, the user is able to make various settings in a simple fashion, just by inputting desired values, and the like, for the items displayed on the settings screen. Accordingly, data relating to settings changes, and the like, is transmitted by the data center 2 to the controller 13, as and when necessary, on the basis of the settings made, and furthermore, processing is carried out in order to adjust the data obtained by the sensor 12 and transmitted via the controller 13. As a result of processing of this kind, a graph such as that illustrated in FIG. 18 is created.

A graph such as that illustrated in FIG. 18 can be monitored by the user, by means of a Web browser (step S55).

The screen examples, setting items, and the like, described above are simply examples and do not indicate limits of any kind.

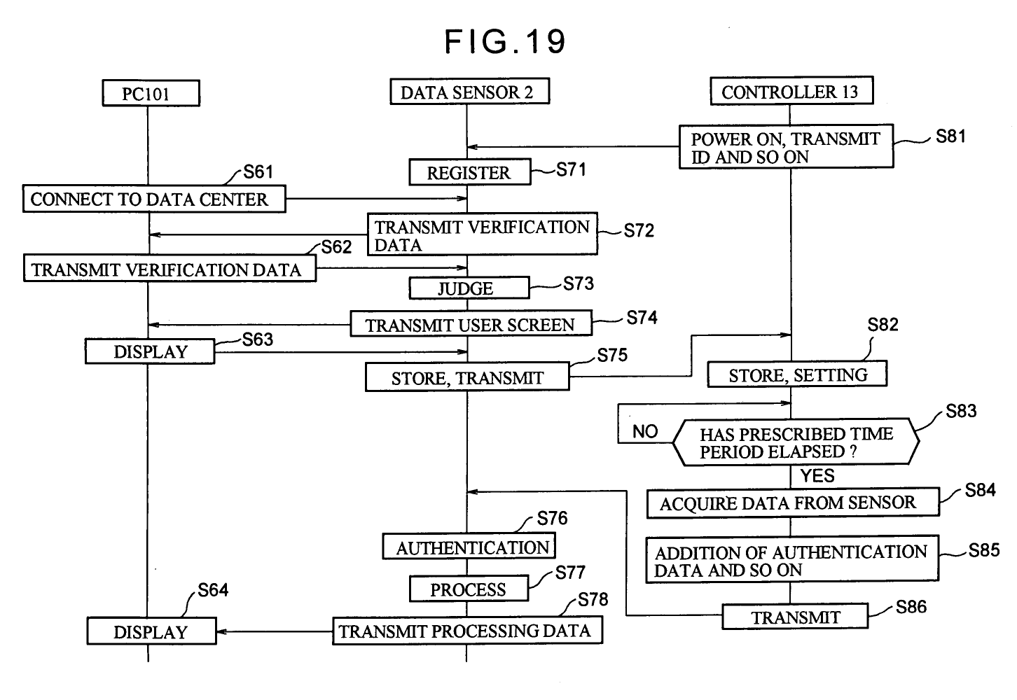

Next, the operation of the information processing system illustrated in FIG. 14 will be described with reference to the flowchart in FIG. 19. At step S53 of the flowchart of the user side operations illustrated in FIG. 16, if the power supply to the controller 13 assumes an on state, then at step S81, the controller 13 transmits an ID, or the like, to the data center 2.

When the processing section 131 of the controller 13 judges that the power supply section 35 has started to supply a power voltage, then it reads out the address (ID) of the actual controller 13, which is stored in the storage section 133, and the address of the data center 2 (for example, the URL: Uniform Resource Locator). On the basis of the addresses thus read out, the controller 13 then establishes a connection with the data center 2, via the network 1.

When a connection has been established, the address of the controller 13 is transmitted to the data center 2. In the present embodiment, it is supposed that the address of the controller 13 transmitted to the data center 2 is a URL that has been allocated to that controller 13. Of course, it is also possible for another element to be assigned as the address. Moreover, the URL assigned to the controller 13 is only assigned to that controller 13, and therefore, it can also be used as an identifier, in other words, an ID.

Upon receiving the address (URL) of the controller 13 transmitted in this manner, at step S71, the data center 2 stores (registers) the URL of the controller 13 thus received in a storage section (not illustrated). When this processing has been completed, a connection between the PC 101 and the data center 2 is established, at step S61. The user of the PC 101 inputs the URL of the controller 13 that he or she has purchased, to the PC 101, and the CPU 151 of the PC 101 establishes a connection with the data center 2, in accordance with the URL thus input. The user is able to tell the URL of the controller 13 that he or she has purchased, by referring to the operating manual that came with the controller on purchase, for instance.

Upon receiving a connection request from the PC 101, the data center 2 refers to the URL concerned and judges what type of controller 13 is related to. At the same time as making this sort of judgment, at step S72, verification screen data for verifying the user is transmitted. A verification screen is, for example, a screen for inputting a user ID and password, as illustrated in FIG. 20. The user inputs his or her user ID and password to the screen of this kind shown on the display 181.

If the user is to be verified by a user ID and password in this way, then it is necessary for the user ID and password to be registered previously in the data center 2. Any mode may be used for this registration process, for instance, it may be carried out by executing processes for registering a user ID and password when the PC 101 accesses the data center 2 for the first time, or by indicating a user ID and password in the operating manual that comes with the controller 13, or it may be carried out by normal post, or the like.

When the user has entered a user ID and password, at step S62, the PC 101 transmits data for verifying that user to the data center 2. At step S73, the data center 2 carries out user verification by using the data thus received. In the data center 2, the user ID and password, and the URL of the controller 13 are managed in a mutually associated manner, and user verification is carried out by judging whether or not the connected URL is the one associated with the user ID and password thus received.

At step S73, if the user is judged to be a legitimate user, as a result of user verification, then the subsequent processing is implemented, but if the user is not judged to be a legitimate user, then the subsequent processing is not implemented.

If the user is judged to be a legitimate user, then the procedure advances to step S74, and the data on the user screen is transmitted. The user screen means the settings screen, graph, and the like, such as those illustrated in FIG. 17 and FIG. 18, for example. Upon receiving this data, at step S63, the PC 101 displays a screen on the basis of this data. Here, it is supposed that a settings screen such as that shown in FIG. 17 has been displayed, and that settings have been input. When information is entered for the setting items, this data is transmitted to the data center 2.

At step S75, the data center 2 stores the received data, and when necessary, also sends this data to the controller 13. In FIG. 17, the stored data comprises data relating to the conversion formula, and data relating to the graph settings, and the like. The data transmitted to the controller 13 comprises data relating to the data acquisition interval, and the like.

At step S82, the controller 13 stores data received from the data center 2. The processing section 131 of the controller 13 then analyses the contents of the data input via the communications section 132, and if, for example, it is judged that this data relates to the data acquisition interval, then this data relating to the data acquisition interval is stored in a storage section 133, and settings are implemented in such a manner that the data obtained by the sensor 12 is transmitted to the data center 2, each time this data acquisition interval has elapsed.

The judgment of whether or not the time period established as the set data acquisition interval (the interval at which data is to be transmitted by the controller 13) has elapsed is made by the processing section 131 at step S83. The controller 13 assumes a standby state until it is judged in step S83 that the prescribed time period thus established has elapsed, and when it is judged that this prescribed time period has elapsed, then the procedure advances to step S84.

At step S84, data is acquired from the sensor 12. Here, it is supposed that data is acquired from the sensor 12 at this timing, but as described above, it is also possible to carry out the acquisition of data from the sensor 12 and the transmission of the data thus obtained to the data center 2, at mutually separate timings (they may be set to separate timings).

When the acquisition of data from the sensor 12 has been completed, at step S85, processing, such as addition of authentication data, or the like, is carried out with respect to the data thus obtained. Authentication data means data that is received by the data center 2 and was definitely transmitted by the controller 13, and this data is used in order to confirm that no illegitimate action, such as falsification, or the like, is being committed. It is possible to use any method of authentication, and data corresponding to the authentication method used is appended.

When the processing in step S85 has been completed, at step S86, transmission is carried out. Upon receiving data from the controller 13, at step S76, the data center 2 uses the authentication data contained in the data thus received in order to perform authentication. In this authentication, if it is judged that the data was definitely transmitted by the controller 13 and that no illegitimate action, such as falsification, or the like, has been committed with respect to the data, then the following processing is implemented, whereas if it is judged that the data was not transmitted by the controller 13 or that the data is related to an illegitimate action, such as falsification, or the like, then the processing below is not implemented.

If, as a result of the authentication operation in step S76, it is judged that the data was transmitted by the controller 13 and that no illegitimate action, such as falsification, or the like, has been committed with respect to the data, then at step S77, processing is carried out with respect to the received data. The processing carried out at step S77 is processing in accordance with the settings made for the conversion formula and the settings may with respect to the graph. The data processed in this way is then transmitted by the data center 2 to the PC 101 at step S78.

At step S78, a prerequisite for the transmission of the data processed by the data center 2 is that the PC 101 is in a connected state with respect to the data center 2. If it is not connected, then it is necessary to establish a connection by means of the PC 101 carrying out the processing in step S61 and step S62, and the data center 2 carrying out the processing in step S72 and step S73, respectively.

At step S64, the PC 101 displays a screen based on the data received from the data center 2, for example, a graph such as that shown in FIG. 18, on the display 181.

In this way, since the PC 101 is able to acquire the data processed by the data center 2, it is possible for the user to use the data from the sensor 12, in a simple fashion. Moreover, by allowing the data to be monitored by means of a Web browser, there is no need for software for performing monitoring to be provided separately on the user side, and hence costs can be reduced, in addition to which, processes relating to monitoring can be carried out readily, thereby improving usability and flexibility.

Since the position at which the sensor 12 and the controller 13 are situated does not depend on the location of the PC 101, then even if sensors 12 and controllers 13 are located in a plurality of diverse locations, it will still be possible to carry out desired processes in a unified manner on the user side, at the location at which the PC 101 is situated. Furthermore, by authenticating the data transmitted by the controller 13, as described above, it is possible to improve reliability.

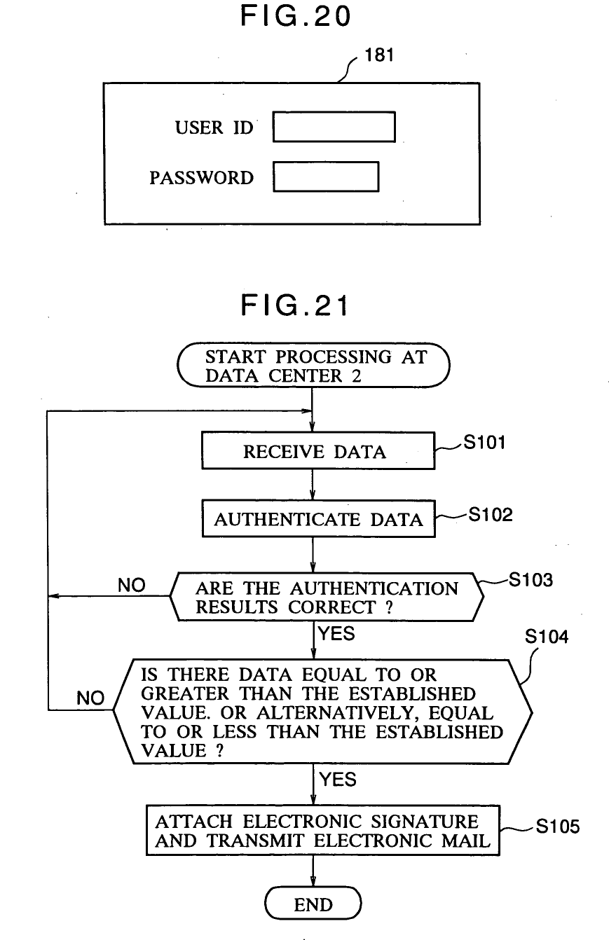

Further processing carried out by the data center 2 is now described with reference to the flowchart in FIG. 21. At step S101, the data center 2 receives data from the controller 13. At step S102, authentication is performed for the data thus received. At step S103, it is judged whether or not the authentication results are correct. The processing from step S101 to S103 has already been described in detail with respect to step S76 in FIG. 19, and hence further description thereof is omitted here.

At step S103, if the authentication results are judged to be correct, then the procedure advances to step S104, where it is judged whether or not there is data that is equal to or greater than, or alternatively, equal to and less than, an established value. The established value is a value set previously by the user as one item of the settings screen described previously with reference to FIG. 17. If it is judged in step S104 that there is no data that is equal to and greater than, or alternatively, equal to and less than, the established value, then the procedure returns to step S101, and the subsequent processing is repeated. At the same time as performing processing of this kind, processing such as that described with reference to the flowchart in FIG. 19 is also carried out.

On the other hand, if it is judged at step S104 that there is data that is equal to or greater than, or alternatively, equal to and less than, the established value, then the procedure advances to step S105, an electronic signature is assigned to the data which is equal to and greater than, or equal to and less than, the established value, and it is transmitted to the user managing the controller 13, in the form of an electronic mail. The mail address to which the electronic mail is transmitted is set as one of the item on the settings screen.

By assigning an electronic signature, it is possible to guarantee the contents of the electronic mail and the sender, and hence reliability can be increased.

In the embodiment described above, it is also possible to encode the data transmitted by the controller 13 and the data transmitted by the data center 2 to the PC 101.

The series of processes described above can be implemented by means of hardware, but they may also be implemented by means of software. If the series of processes are implemented by means of software, they may be installed from a storage medium in a computer in which the programs constituting this software are incorporated into special hardware, or in a generic personal computer, for example, which is capable of executing a variety of functions, by installing various programs therein.

As shown in FIG. 10 or FIG. 15, the storage medium is not only constituted by package media separate from the personal computer 30, 101, consisting of a magnetic disk 51, 171 (comprising flexible disk), an optical disk 52, 172 (including a CD-ROM (Compact Disc-Read Only Memory), DVD (Digital Versatile Disk) or the like), an opto-magnetic disk 53, 173 (including an MD (Mini-Disc) (registered trademark)), or a semiconductor memory 54, 174, or the like, on which a program is stored and which is distributed in order to supply the program to the user, and it is may also be constituted by a hard disk, or the like, comprising a ROM 32, 152, or storage section 38, 158, on which programs are stored and which is supplied to the user by being previously incorporated into the computer.

In the present specification, the step of defining the program supplied by means of the medium naturally includes processing carried out consecutively in accordance with the described order, but processing does not necessarily have to carried out consecutively, and processing carried out in a parallel fashion or a separate fashion may also be included.

In the present specification, a system indicates an overall device constituted by a plurality of devices.

### INDUSTRIAL APPLICABILITY

As described above, according to the first aspect of the present invention, since a first information processing device measures the remaining amount of a prescribed material and transmits that data to a second information processing device, the second information processing device receives data relating to the remaining amount from the first information processing device and transmits this data to a third information processing device, and the third information processing device receives data relating to the remaining amount and predicts the point in time at which the remaining amount of the prescribed material will become zero, by using this data, it is therefore possible to manage the remaining amount of the material managed at a distant position, and it is also possible to carry out replenishment in a highly efficient manner, at the time that the remaining amount of material becomes zero.

According to the second aspect of the present invention, since the point in time at which the remaining amount of a prescribed material will become zero is predicted, by using data relating to the remaining amount of the prescribed material as obtained by another information processing device, and since processing relating to the replenishment of the material is carried out on the basis of this prediction, it is possible to carry out delivery of the material in a highly efficient manner, on the basis of this prediction.

According to the third aspect of the present invention, since a first information processing device transmits the measurement results measured by sensors, and an ID assigned to itself, to a second information processing device, and receives data from the second information processing device and makes settings on the basis of the data thus received, and since the second information processing device processes the received measurement results on the basis of settings items established with respect to the measurement results processed and stored in association with the aforementioned ID, and transmits data relating to settings for the first information processing device from a third information processing device, to the first information processing device, and since the third information processing device transmits data relating to settings in the first information processing device, and data relating to settings items established with respect to the measurement results, to the second information processing device, it is therefore possible to perform management of the sensors in a simple fashion at the third information processing device, and furthermore, it is also possible to monitor and manage the measurement results obtained by the sensors, in a simple fashion.

According to the fourth aspect of the invention, since the measurement results measured by the sensors are transmitted, together with an ID assigned to same, to another device, and since data from the other device is received and settings are made on the basis of the data thus received, it is possible to perform management of the sensors by means of the other device, and it is also possible for a user to carry out processes, such as managing the sensors, or monitoring the measuring results obtained from same, or the like, in a simple fashion.

According to a fifth aspect of the invention, since an ID for identifying the first device is received with the measurement results measured by the sensors and transmitted by the first device, the measurement results thus received being processed on the basis of settings items established with respect to the processing of the measurement results and stored in association with the ID, and since data relating to the settings items and data relating to the settings of the first device is received from the second device and the data relating to the settings of the first device thus received is transmitted to the first device, whilst the processed measurement results are supplied to the second device, then at the second device located on the user side, it is possible to manage the first device, and it is also possible for the user to carry out processes, such as monitoring the measurement results acquired by the first device, and the like, in a simple fashion.

1. An information processing system constituted by a first information processing device and a second information processing device for carrying out prescribed processing on the basis of data relating to the measured remaining amount of a prescribed material, characterized in that:
said first information processing device receives data relating to the remaining amount of said prescribed material from another information processing device, and predicts the point in time at which the remaining amount of said prescribed material will become a prescribed amount, on the basis of the change in said remaining amount as determined from the received data relating to said remaining amount; and transmits the predicted point in time at which the remaining amount of said prescribed material will become said prescribed amount, to said second information processing device; and
said second information processing device receives the point in time at which the remaining amount of said prescribed material will become said prescribed amount from said first information processing device, acquires positional information relating to a vehicle carrying out delivery of said material in order to perform replenishment of said material, and calculates the point in time at which said vehicle is to deliver said material, by using the received point in time at which the remaining amount of said prescribed amount will become said prescribed amount, and said positional information thus acquired.

2. The information processing system according to claim 1, characterized in that said prescribed amount is zero.

3. The information processing system according to claim 1, characterized in that, if the difference between the remaining amount at the point in time at which replenishment of said material was carried out, and the remaining amount determined from the received data relating to said remaining amount, is taken to be remaining amount difference W1, the time period required for this remaining amount difference W1 to arise is taken to be time period T1, and the remaining amount determined from the received data relating to said remaining amount is taken to be remaining amount W2, then the time period T2 from the current time T until the point in time at which the remaining amount of said material will become said prescribed amount is derived by calculating T1×(W2/W1), and the point in time at which the remaining amount of said material will become said prescribed amount is predicted by adding the time period T2 thus calculated to said current time T;
said prediction being made without including the time period required for the change in said remaining amount difference W1 to arise, in said time period T1, if said amount of change is within a prescribed range.

4. The information processing device according to claim 1, characterized in that said first information processing device receives data relating to the remaining amount of said prescribed material from said other information processing device, on the basis of the change in said remaining amount as determined from the data relating to said remaining amount.

5. An information processing method for an information processing system constituted by a first information processing device and a second information processing device for carrying out prescribed processing on the basis of data relating to the measured remaining amount of a prescribed material, characterized in that:
the information processing method for said first information processing device receives data relating to the remaining amount of said prescribed material from another information processing device, and predicts the point in time at which the remaining amount of said prescribed material will become a prescribed amount, on the basis of the change in said remaining amount as determined from the received data relating to said remaining amount; and transmits the predicted point in time at which the remaining amount of said prescribed material will become said prescribed amount, to said second information processing device; and
the information processing method for said second information processing device receives the point in time at which the remaining amount of said prescribed material will become said prescribed amount from said first information processing device, acquires positional information relating to a vehicle carrying out delivery of said material in order to perform replenishment of said material, and calculates the point in time at which said vehicle is to deliver said material, by using the received point in time at which the remaining amount of said prescribed amount will become said prescribed amount, and said positional information thus acquired.

6. An information processing device characterized in comprising:
receiving means for receiving data relating to the remaining amount of a prescribed material from another information processing device;
predicting means for predicting the point in time at which the remaining amount of said prescribed material will become a prescribed amount, on the basis of the change in said remaining amount as determined from the data relating to said remaining amount received by said receiving means;
acquiring means for acquiring positional information for a vehicle carrying out delivery of said material in order to perform replenishment of said material; and
calculating means for calculating the point in time at which said vehicle is to deliver said material, by using the point in time at which the remaining amount of said prescribed material will become said prescribed amount, as predicted by said predicting means, and said positional information acquired by said acquiring means.

7. The information processing device according to claim 6, characterized in that said prescribed amount is zero.

8. The information processing device according to claim 6, characterized in that, if the difference between the remaining amount at the point in time at which replenishment of said material was carried out, and the remaining amount determined from the received data relating to said remaining amount received by the receiving means, is taken to be remaining amount difference W1, the time period required for this remaining amount difference W1 to arise is taken to be time period T1, and the remaining amount determined from the received data relating to said remaining amount received by said receiving means is taken to be remaining amount W2, then the predicting means derives the time period T2 from the current time T until the point in time at which the remaining amount of said material will become said prescribed amount by calculating T1×(W2/W1), and predicts the point in time at which the remaining amount of said material will become said prescribed amount by adding the time period T2 thus calculated to said current time T;
said predicting means making said prediction without including the time period required for the change in said remaining amount difference W1 to arise, in said time period T1, if said amount of change is within a prescribed range.

9. The information processing device according to claim 6, characterized in that said receiving means receives data relating to the remaining amount of said prescribed material from said other information processing device, on the basis of the change in said remaining amount as determined from said data relating to said remaining amount.

10. An information processing method characterized in comprising:
a receiving step for receiving data relating to the remaining amount of a prescribed material from an information processing device;
a predicting step for predicting the point in time at which the remaining amount of said prescribed material will become a prescribed amount, on the basis of the change in said remaining amount determined from the data relating to said remaining amount received by means of the processing in said receiving step;
an acquiring step for acquiring positional information relating to a vehicle carrying out delivery of said material in order to perform replenishment of said material; and
a calculating step for calculating the point in time at which said vehicle is to deliver said material, by using the point in time at which the remaining amount of said prescribed material will become said prescribed amount, as predicted by means of the processing in said predicting step, and said positional information acquired by means of the processing in said acquiring step.

11. An information processing system constituted by a first information processing device for acquiring measurement data measured by means of sensors, a second information processing device for processing said measurement data from said first information processing device, and a third information processing device to which said measurement data processed by said second information processing device is supplied, characterized in that:
said first information processing device acquires said measurement data measured by said sensors, stores an ID assigned to itself, and transmits said measurement data thus acquired, and said stored ID, to said second information processing device;
said second information processing device receives said measurement data and said ID from said first information processing device, receives data relating to settings items including processing information for processing said ID and said measurement data from the third information processing device, registers the received data relating to said settings items in association with said ID, transmits the received data relating to said settings items to said first information processing device, on the basis of said ID, processes the received measurement data on the basis of data relating to said settings items registered in association with said ID, and supplies said measurement data thus processed to said third information processing device; and
said third information processing device controls the display of said measurement data supplied by said second information processing device, and transmits said data relating to settings items, to said second information processing device, together with said ID.

12. An information processing device characterized in comprising:
measurement data receiving means for receiving measurement data as measured by sensors, and an ID for identifying a first device, from said first device;
settings data receiving means for receiving data relating to settings items including processing information for processing said ID and said measurement data, from a second device;
registering means for registering said data relating to settings items received by said settings data receiving means, in association with said ID;
data transmitting means for transmitting data relating to said settings items received by said settings data receiving means, to said first device, on the basis of said ID;
processing means for processing said measurement data received by said measurement data receiving means, on the basis of data relating to said settings items registered in association with said ID by said registering means; and
supplying means for supplying said measurement data processed by said processing means, to said second device.

13. The information processing device according to claim 12, characterized in further comprising mail transmitting means that compares said measurement data received by said measurement data receiving means with an upper limit value or lower limit value established as one of said setting items, and if said comparison result indicates that said measurement data is equal to or greater than said upper limit value, or that said measurement result is equal to or lower than said lower limit value, then transmits an electronic mail indicating this fact, together with an attached electronic signature, to an established electronic mail address.

14. An information processing method characterized in comprising:
a measurement data receiving step for receiving measurement data as measured by sensors, and an ID for identifying a first device, from said first device;
a settings data receiving step for receiving data relating to settings items including processing information for processing said ID and said measurement data, from a second device;
a registering step for registering said data relating to settings items received by means of the processing in said settings data receiving step, in association with said ID;
a data transmitting step for transmitting data relating to said settings items received by means of the processing in said settings data receiving step, to said first device, on the basis of said ID;
a processing step for processing said measurement data received by means of the processing in said measurement data receiving step, on the basis of data relating to said settings items registered in association with said ID by means of the processing in said registering step; and
a supplying step for supplying said measurement data processed by means of the processing in said processing step, to said second device.

15. (Deleted)

16. (Deleted)
